(19) United States
(12) Patent Application Publication
(10) Pub. No.: US 2021/0221553 A1
(43) Pub. Date: Jul. 22, 2021

(54) Container with Multiple Openings for Holding a Liquid

(71) Applicant: Evansfield Distillery Business Group LLC, Lee's Summit, MO (US)

(72) Inventors: Dennis D. Evans, Lee's Summit, MO (US); John C. Whitfield, Nashville, TN (US)

(21) Appl. No.: 16/748,282

(22) Filed: Jan. 21, 2020

(51) Int. Cl. B65D 1/06; B65D 8/00; B65D 41/04; B65D 51/24

(52) U.S. Cl. CPC B65D 1/06; B65D 15/04; B65D 41/0457; B65D 2251/0028; B65D 2251/205; B65D 2251/0078; B65D 51/249

(57) ABSTRACT

A container that includes: a body; a first opening at a first end of the body and a second opening at a second end of the body, where the second end of the body additionally includes a plurality of threads on an exterior surface of the body; a lid assembly capable of being affixed to the second opening, where the lid assembly includes a band, a lid, and a sealant; a cover to conceal the lid assembly.

### BACKGROUND

It is well known that various types of containers exist for containing a liquid, for example, spirits, such as ethyl or ethanol alcohol based beverages. Conventionally, these containers have a single opening through which the liquid may flow. For example, alcoholic beverages, after they have been distilled, must be subjected to an aging operation which removes harmful or unpleasant constituents and greatly improves the potability of the beverage. The most satisfactory and widely used aging process involves bringing the liquor into contact with wood for an extended period of time. This is normally accomplished by storing the liquor in large wooden kegs or barrels for the period of time required, after which the aged liquor is put into containers, such as bottles, and shipped. The liquor may stand in the bottles for a long period of time before it is consumed, but no aging whatsoever takes place during this latter period because of the material of which the bottle is made (e.g. glass).

It may be desirable to permit the liquor to age while in the bottle, as a substitute either for all or a part of the time that it is normally stored within wooden barrels. One method of aging a liquor in the bottle includes adding a wooden medallion to the bottle, for example see U.S. Pat. No. 10,041,027, incorporated by reference herein. However, in many instances, these medallions are larger than the traditional bottle opening. There exists a need for a container (e.g. a bottle) for holding a liquid with multiple openings.

### SUMMARY

Accordingly, the present disclosure is directed towards a bottle with multiple openings to contain a liquid, for example, spirits, such as ethyl or ethanol alcohol based beverages. Generally, in one aspect, a container consistent with some embodiments herein includes: a body; a first opening at a first end of the body and a second opening at a second end of the body, where the second end of the body additionally includes threads on an exterior surface of the body; a lid assembly which is capable of being affixed to the second opening and includes a band, a lid, and a sealant; and a cover to conceal the lid assembly.

In some embodiments, the first opening has a first diameter and the second opening has a second diameter wherein the first diameter is smaller than the second diameter.

In some embodiments, the band further comprises a plurality of threads on an interior surface of the band. In some such embodiments, the sealant is adapted to form a liquid-tight seal upon exertion of pressure in coupling the plurality of threads on the interior surface of the band with the plurality of threads on the exterior surface of the body.

In some embodiments, the sealant is a wax coating on a perimeter of the lid. In other embodiments, the sealant is a rubber gasket disposed on a perimeter of the lid. In some embodiments, the lid further comprises a raised center and a perimeter portion, the perimeter portion containing the sealant.

In some embodiments, the cover is constructed of wood, plastic, or metal.

In another aspect, a container consistent with the embodiments disclosed herein, includes: a glass body; a first opening at a first end of the glass body and a second opening at a second end of the body, where the first opening has a first diameter and the second opening has a second diameter, and wherein the first diameter is smaller than the second diameter, and where the second end of the body further includes a plurality of threads on an exterior surface of the body; a lid assembly to form a liquid-tight seal at the second opening, the lid assembly including a band, a lid, and a sealant; and a wooden cover to conceal the lid assembly.

In some embodiments, the band additionally includes a plurality of threads on an interior surface of the band. In some such embodiments, the sealant is adapted to form the liquid-tight seal upon exertion of pressure from coupling the plurality of threads on the interior surface of the band with the plurality of threads on the exterior surface of the body.

In some embodiments, the sealant is a wax coating on a perimeter of the lid. In other embodiments, the sealant is a rubber gasket disposed on a perimeter of the lid. In some embodiments, the lid further comprises a raised center and a perimeter portion, the perimeter portion containing the sealant.

In some embodiments, a stopper is removably disposed within the first opening of the glass body to form a liquid-tight seal. In some such embodiments, the stopper is cork, rubber, or a threaded cap.

In yet another aspect, a container consistent with some embodiments herein includes: a glass body; a first opening at a first end of the glass body with a stopper removably disposed within the first opening of the glass body to form a liquid-tight seal; a second opening at a second end of the body including a plurality of threads on an exterior surface of the body, where the first opening has a first diameter and the second opening has a second diameter, and wherein the first diameter is smaller than the second diameter; a lid assembly to form a liquid-tight seal at the second opening, the lid assembly including: a band including a plurality of threads on an interior surface of the band, a lid, and a sealant disposed on a perimeter of the lid, where the sealant is adapted to form the liquid-tight seal upon exertion of pressure from coupling the plurality of threads on the interior surface of the band with the plurality of threads on the exterior surface of the body; and a cover to conceal the lid assembly.

In some embodiments, the second diameter is at least twice the first diameter.

It should be appreciated that all combinations of the foregoing concepts and additional concepts discussed in greater detail below are not mutually inconsistent and are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

In order that the embodiments may be better understood, embodiments of the bottle with multiple openings for containing a liquid will now be described by way of examples. These embodiments are not to limit the scope of the claims as other embodiments of the bottle will become apparent to one having ordinary skill in the art upon reading the instant description. Non-limiting examples of the present embodiments are shown in figures wherein:

FIG. 1 is a perspective view of an example container with multiple openings containing a liquid and a medallion, consistent with some embodiments described herein.

FIG. 2 is a perspective view of the container of FIG. 1 empty, consistent with some embodiments described herein.

FIG. 3 is a cross-sectional view of the container of FIG. 2, consistent with some embodiments described herein.

FIG. 3A illustrates an enlarged section of the container of FIG. 3, consistent with some embodiments described herein.

FIG. 4 is an exploded view of the container of FIG. 2, consistent with some embodiments described herein.

FIG. 5 illustrates a top perspective view of the lid assembly and cover of FIGS. 1 and 2, consistent with some embodiments described herein.

FIG. 6 illustrates a bottom perspective view of the lid assembly of FIG. 5, consistent with some embodiments described herein.

### DETAILED DESCRIPTION

It is to be understood that the container (e.g. bottle) is not limited in its application to the details and the arrangement of components set forth in the following description or illustrated in the drawings. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

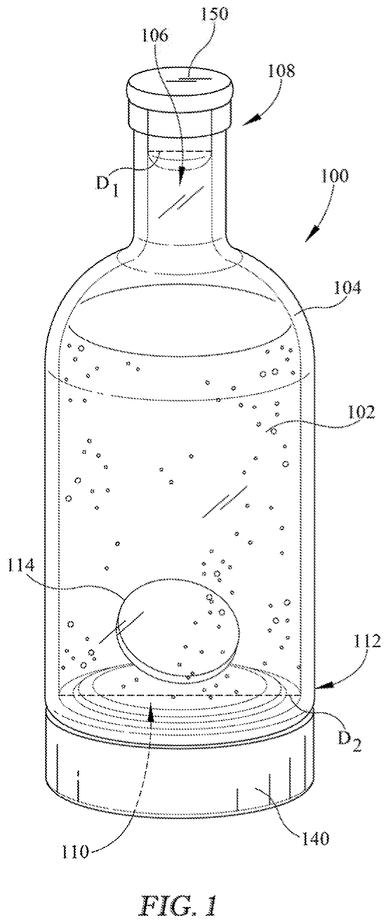

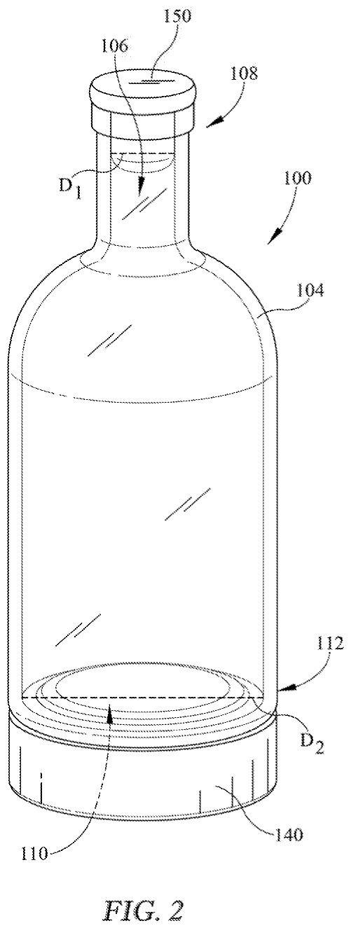

Referring now in detail to the drawings, wherein like numerals indicate like elements throughout several views. FIGS. 1 through 4 illustrate a container 100, such as a bottle, for containing a liquid 102. The container 100 may include a body 104. The body 104 may define the shape and aesthetic appearance of the container 100. For example, as illustrated in FIGS. 1 through 4 the body 104 may be constructed in the form of a bottle, but this is not intended to be limiting, as the body may take on any form desired for a particular aesthetic appearance. In some instances, the body 104 may be constructed of glass, although this too is not limiting, as in other instances the body 104 may be constructed of a durable plastic. In many instances, it may be desirable for the body 104 to be translucent allowing a user to easily see the contents of the container 100.

The body 104 may also include a first opening 106 disposed at a first end 108 of the container 100 and a second opening 110 disposed at an opposing second end 112 of the container 100. In some instances, the first opening 106 may have a first diameter D1, while the second opening 110 has a different second diameter D2. The first diameter D1 may be smaller than the second diameter D2, with the respective diameters typically being of various sizes.

The container 100 may take on any form of container suitable for containing a liquid. In some instances the liquid 102 may be a distilled spirit unaged, partially aged, or fully aged, such as an ethyl or ethanol based liquid product. The ethyl or ethanol based liquid product may include, but is not limited to, whiskey, bourbon, rum, vodka, tequila, cognac, gin, moonshine, or wine. In some instances, such as illustrated in FIG. 1, the container 100 may additionally contain a wooden medallion 114, which may be configured to facilitate the aging process of the distilled spirit, such as described in U.S. Pat. No. 10,041,027, incorporated by reference herein. The medallion 114 may, for example, be larger in diameter than the first opening 106, but smaller in diameter than the second opening 110. Although illustrated as circular or disc shaped in FIG. 1, the medallion 114 is not so limited, and can be of any shape as outlined in U.S. Pat. No. 10,041,027, incorporated by reference herein.

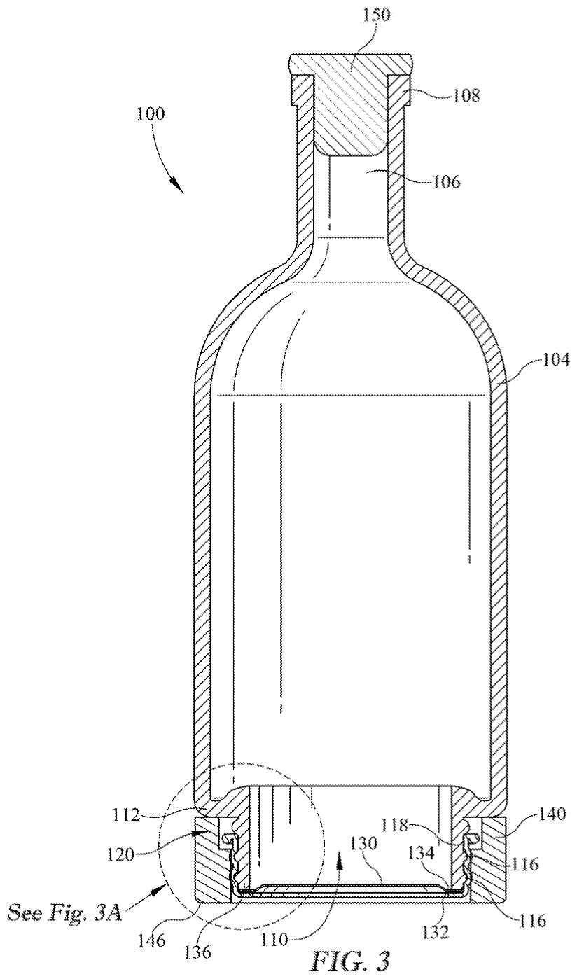

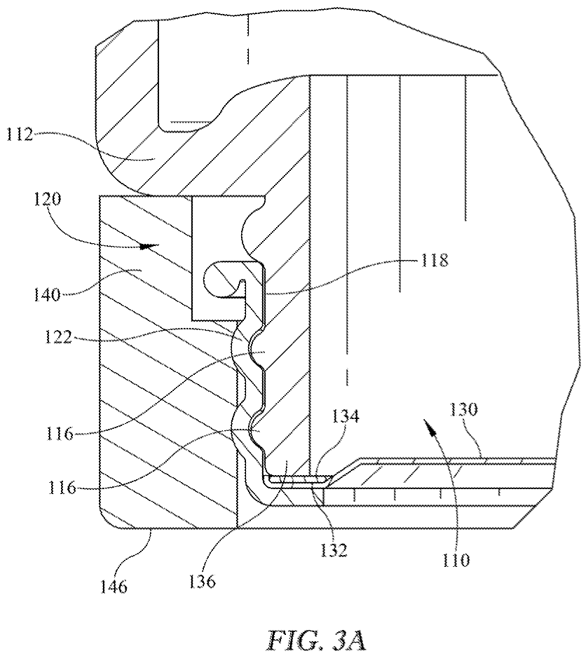

Turning now to the second end 112 of the container 100, which is best illustrated in FIGS. 3 and 3A (cross-sectional views) and FIG. 4 (exploded view). The second opening 110 of the container 100 may include a plurality of threads 116 on an exterior surface 118 of the body 104. The illustrated embodiment is not intended to be limiting, as both the number and arrangement (e.g. the curvature angle, etc.) of the individual threads 116 may vary. The plurality of threads 116 on the exterior of the second end 112 may couple with a lid assembly 120 (described in detail herein) to provide a liquid-tight seal at the second end 112 of the container 100. In some instances, the lid assembly 120 may be removably affixed to the second end 112 of the container 100 allowing the container 100 to be opened or closed at the second end 112 as desired. In other instances, the lid assembly 120 may be permanently affixed to the second end 112 of the container 100. Generally, the lid assembly 120 may include a band 122, a lid 128, and/or a sealant 134.

The band 122 component of the lid assembly 120 may be substantially the same shape as the second opening 110, for example circular as illustrated in the Figures, and may be configured to surround the second end 112 of the body 104. In some instances, the band 122 may be in the form of a ring, with an open top and bottom. The band 122 may include a plurality of threads 124 on an interior surface 126 that may be configured to couple with the plurality of the threads 116 on the exterior surface 118 of the body 104. For example, the plurality of threads 116, 124 may couple together through a rotational or twisting motion. In some embodiments, the band 122 may be constructed of stainless steel; in other embodiments, the band 122 may be constructed of a durable plastic or other material known in the art. A lid 128 may be configured to couple with the band 122. In some instances, the lid may be substantially flat, including a center 130 and a perimeter portion 132. In some embodiments, the center 130 may also be slightly raised as compared to the perimeter portion 132. The perimeter portion 132 may also be slightly recessed as compared to the remainder of the lid 128. The lid 128 may have a third diameter D3 that may be larger than the second opening 110, so as to fully cover the second opening 110. Similar to the band 122, the lid 128 may, in some embodiments, be constructed of stainless steel; while in other embodiments, the lid 128 may be constructed of another durable material, for example plastic. Although illustrated and described as separated pieces, this is not to be understood as limiting, as in some embodiments the band 122 and lid 128 may be constructed as a single piece.

The lid assembly 120 may also include a sealant 134 to facilitate the formation of a liquid-tight seal at the second opening 110. In some embodiments, the sealant 134 may be a wax coating, which, for example, may be a food-grade wax. In other embodiments, the sealant may be a rubber gasket. The sealant 134 may be disposed on the perimeter 132 of the lid 128 such that it contacts an end surface 136 of the second opening 110. In some instances, the sealant 134 may form a liquid-tight seal upon exertion of pressure from the coupling, for example through rotation or twisting, of the plurality of threads 124 on the interior surface 126 of the band 122 with plurality of threads 116 on the exterior surface 118 of the body 104. The sealant 134 may be a separate piece, or may also be incorporated as a part of the lid 128.

It may be desirable to cover the lid assembly 120 to provide a more stable base for the container 100 as well as a more aesthetically pleasing appearance; therefore, in some instances, the container 100 may also include a cover 140 to conceal at least a portion of the lid assembly 120. For example, the cover 140 may envelop the portion of the lid assembly 120 visible when the container 100 is sitting in an upright position (as illustrated in FIGS. 1-3). In some instances, the cover 140 may be constructed of wood, or any other visually appealing material such as plastic (which may be colored) or metal. In some instances, as best illustrated in FIGS. 1-3 the cover 140 may have a shape and diameter equal to that of the body 104 of the container 100. This may allow the cover 140 to provide a stable base for container 100. In some instances, the cover 140 may be permanently affixed to the lid assembly, for example through the use of an adhesive. In other instances, the cover 140 may be removably affixed to the lid assembly 120. In still other instances, the container 100, in particular the second end 112 may simply sit in the cover 140. The interior surface 142 of the cover 140 may, in some instance, additionally include a ledge 144 that the band 122 of lid assembly 120 may sit on.

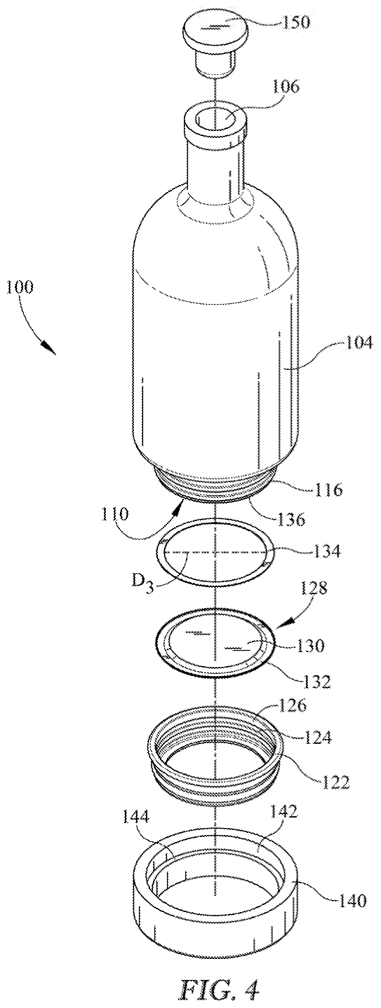

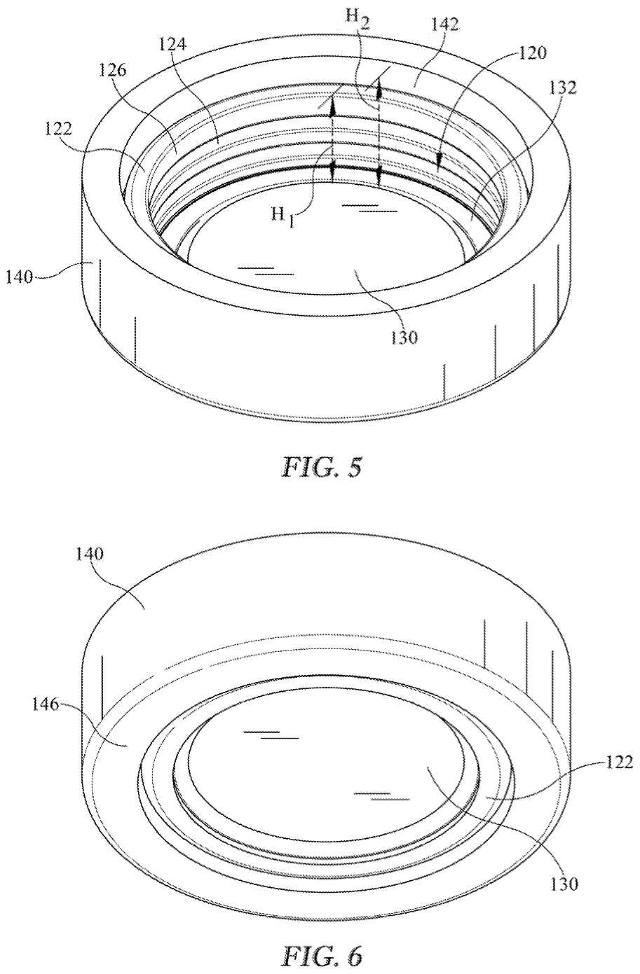

Referring now specifically to FIGS. 5 and 6, each of which illustrate the lid assembly 120 and cover 140 separate from the body 104 of the container 100. FIG. 5 is a top perspective view of the lid assembly 120 and cover 140; and, in this view the interior surface 124 of the band 122, including the plurality of threads 126 that may facilitate coupling with the second end 112 of the container 100, are visible. As is illustrated in FIG. 5, the cover 140 may completely envelope the band 122; and, in some instances, the cover 140 may have a height H1 that exceeds the height H2 of the band 122. The center 130 and perimeter portions 132 of the lid 128 are also visible in this view.

FIG. 6 is a bottom perspective view of the lid assembly 120 and the cover 140 separate from the body 104 of the container 100. In this view, a lower surface 146 of the cover 140 is shown; the lower surface 146 may be the portion of the cover 140 that rests flat on a surface (such as a table) when the container 100 is in an upright position (such as illustrated in FIGS. 1-3). The center 130 of the lid assembly may be recessed within the cover 140, such that the center 130 may not come into contact with the flat surface on which the container is resting. In some instances, the recessed positioning of the cover 140 (and entire lid assembly 120) may be a result of the ledge 144 (illustrated in FIG. 4).Turning now to the first end 108 of the container 100, a stopper 150 is illustrated within the first opening 106. This stopper 150 may be removably disposed within the first opening 106 in order to form a liquid-tight seal. The stopper 150 may be removed from the first opening 106 in order to allow the container 100 to be opened so that, for example, a liquid may be poured out of the first opening 106.

In some instances, such as illustrated in the Figures the stopper 150 may be formed of cork, rubber, or the like. In other instances, the stopper 150 may be a threaded cap. In such an instance, the first opening 106 of the container 100 as well as the stopper in the form of a threaded cap may include a plurality of thread (similar to those described herein) in order to couple together.

The foregoing description of various embodiments of the invention has been presented for purposes of illustration. It is not intended to be exhaustive or to limit the invention to the precise forms disclosed, and obviously many modifications and variations are possible in light of the above teaching. It is intended that the scope of the invention and all equivalents be defined by the claims appended hereto.

What is claimed is:

1. A container comprising:
a body;
a first opening at a first end of the body and a second opening at a second end of the body;
wherein the second end of the body further includes a plurality of threads on an exterior surface of the body;
a lid assembly capable of being affixed to the second opening, comprising:
a band,
a lid, and
a sealant; and
a cover to envelop at least a portion of the lid assembly.

2. The container of claim 1, wherein the first opening has a first diameter and the second opening has a second diameter and the first diameter is smaller than the second diameter.

3. The container of claim 1, wherein the band further comprises a plurality of threads on an interior surface of the band.

4. The container of claim 3, wherein the sealant is adapted to form a liquid-tight seal upon exertion of pressure from coupling the plurality of threads on the interior surface of the band with plurality of threads on the exterior surface of the body.

5. The container of claim 1, wherein the sealant is a wax coating on a perimeter of the lid.

6. The container of claim 1, wherein the sealant is a rubber gasket disposed on a perimeter of the lid.

7. The container of claim 1, wherein the lid further comprises a raised center and a perimeter portion, the perimeter portion containing the sealant.

8. The container of claim 1, wherein the cover is constructed of wood, plastic, or metal.

9. A container comprising:
a glass body;
a first opening at a first end of the glass body and a second opening at a second end of the glass body;
wherein the first opening has a first diameter and the second opening has a second diameter and the first diameter is smaller than the second diameter, and
wherein the second end of the glass body further includes a plurality of threads on an exterior surface of the glass body;
a lid assembly to form a liquid-tight seal at the second opening, comprising:
a band,
a lid, and
a sealant; and
a wooden cover to conceal at least a portion of the lid assembly.

10. The container of claim 9, wherein the band further comprises a plurality of threads on an interior surface of the band.

11. The container of claim 10, wherein the sealant is adapted to form the liquid-tight seal upon exertion of pressure from coupling the plurality of threads on the interior surface of the band with plurality of threads on the exterior surface of the glass body.

12. The container of claim 9, wherein the sealant is a wax coating on a perimeter of the lid.

13. The container of claim 9, wherein the sealant is a rubber gasket disposed on a perimeter of the lid.

14. The container of claim 9, wherein the lid further comprises a raised center and a perimeter portion, the perimeter portion containing the sealant.

15. The container of claim 9, wherein a stopper is removably disposed within the first opening of the glass body to form a liquid-tight seal.

16. The container of claim 15, wherein the stopper is cork, rubber, or a threaded cap.

17. A container comprising:
a glass body;
a first opening at a first end of the glass body with a stopper removably disposed within the first opening of the glass body to form a liquid-tight seal;
a second opening at a second end of the glass body including a plurality of threads on an exterior surface of the glass body;
wherein the first opening has a first diameter and the second opening has a second diameter and the first diameter is smaller than the second diameter;
a lid assembly to form a liquid-tight seal at the second opening, comprising:
a band including a plurality of threads on an interior surface of the band,
a lid, and
a sealant disposed on a perimeter of the lid;
wherein the sealant is adapted to form the liquid-tight seal upon exertion of pressure from coupling the plurality of threads on the interior surface of the band with plurality of threads on the exterior surface of the glass body; and
a cover to conceal at least a portion of the lid assembly.

18. The container of claim 17, wherein the second diameter is at least twice the first diameter.
